(19) United States
(12) Patent Application Publication
(10) Pub. No.: US 2018/0184202 A1
(43) Pub. Date: Jun. 28, 2018

(54) SOUNDBAR

(71) Applicant: Fraunhofer-Gesellschaft zur Foerderung der angewandten Forschung e.V., Munich (DE)

(72) Inventors: Andreas WALTHER, Feucht (DE); Christian BORSS, Erlangen (DE); Martin SCHNEIDER, Erlangen (DE); Philipp GOETZ, Berlin (DE)

(21) Appl. No.: 15/887,182

(22) Filed: Feb. 2, 2018

Related U.S. Application Data
(63) Continuation of application No. PCT/EP2016/067393, filed on Jul. 21, 2016.

(30) Foreign Application Priority Data
Aug. 3, 2015 (EP) 15179585.3

(51) Int. Cl. H04R 5/02; H04R 1/34; H04R 3/12

(52) U.S. Cl. CPC H04R 5/02; H04R 1/345; H04S 3/002; H04R 2205/022; H04R 2205/024; H04R 3/12

(57) ABSTRACT

A soundbar includes a housing, at least two transducers of a first group and at least one transducer of a second group. The at least two transducers of the first group are arranged at the front side of the housing and configured to emit sound in a first direction in accordance with two first audio signals so as to reproduce a two dimensional sound field. The at least one transducer of a second group is arranged at second side of the housing and configured to emit sound in a second direction in accordance with a second audio signal such that the sound emitted by the at least one transducer of the second group reaches a predefined listener's position in a reflected manner to extend the two dimensional sound field in a height direction. The reflection reflecting the sound emitted by the at least one transducer of the second group has an order of at least two.

### CROSS-REFERENCE TO RELATED APPLICATIONS

This application is a continuation of copending International Application No. PCT/EP2016/067393, filed Jul. 21, 2016, which is incorporated herein by reference in its entirety, and additionally claims priority from European Application No. EP 15 179 585.3, filed Aug. 3, 2015, which is incorporated herein by reference in its entirety.

Embodiments of the present invention refer to a soundbar, especially to a soundbar with height loudspeakers. Further embodiments refer to a system comprising a soundbar and a screen.

### BACKGROUND OF THE INVENTION

Today's movie soundtracks are delivered in surround sound produced for a varying number of reproduction channels. The most recent audio formats offer the possibility of immersive sound reproduction. Wth immersive formats, the legacy surround sound formats (e.g. 5.1 or 7.1), which can only faithfully reproduce sound on a horizontal plane, are extended with loudspeakers positioned in different heights. Thereby a faithful reproduction of sound in a 3D space is possible.

While audio enthusiasts might install loudspeakers at useful positions—including height speakers—most consumers tend to avoid the effort of installing conventional surround sound setups. Hence, it can be expected that mounting additional loudspeakers on the ceiling will be favored by even less consumers. Nonetheless, those home consumers also want to benefit from enhanced sound quality.

To yield high-quality sound reproduction without the need to install standalone loudspeakers, soundbars have become popular. They offer better sound quality than most of the loudspeakers built into flat screens, and by special processing and loudspeaker layouts they even allow to reproduce virtual surround sound.

To reproduce three-dimensional acoustic scenes, the excited wave fronts may impinge on the listener's position also from a broad range of directions in the upper hemisphere. Hence, it is not sufficient that wave fronts travel only in the azimuthal plane. Instead, parts of the acoustic scene may be reproduced from above the listener's position, which is a major obstacle in the design of a compact playback system.

According to known technology there are some concepts for delivering 3D sound by using reflective surfaces. The reflected sound is specifically used to address the problem of 3D sound reproduction without the need to install height loudspeakers (which may also have a different frequency range when compared to the other loudspeakers). Such a system is described in the WO 2014/036085. Here, the loudspeaker system renders spatial audio content, wherein the sound is reflected off a surface like the ceiling to the listener's position. For this, one or more upward tilted drivers are provided. These are positioned such that they project sound at an angle up to the ceiling where it can then be bounced back down to the listener. The degree of the tilt may be set depending on listening environment characteristics and system requirements. For example, the upward firing driver may be tilted up between 30° and 60°. For certain sounds, such as ambient sound, the upward-firing driver may be pointed straight up out of an upper surface of the speaker enclosure to create what might be referred to as a lop firing' driver. The upward-firing drivers would be positioned such that the angle between the median plane of the driver and the acoustic center would be an angle in the range of 45° to 180°. In the case of positioning the driver at 180°, the back-facing driver could provide sound diffusion by reflecting off of a back-wall. However, each embodiment according to WO 2014/036085 is described the context of 5.1 or 7.1 setups. Here, cabinets are placed in the traditional positions (5.1 or 7.1) and equipped with an additional driver pointing generally upwards but being slightly tilted towards the listener. The tilt of the driver is chosen such that the directional sound waves are reflected at the ceiling towards the listener position. This approach may not be optimal with regard to be sufficiently directional, especially for a broad frequency range. Thus, a considerable residual part of the emitted wave field reaches the listener directly, which can degrade the impression of a sound impinging from above. A solution according to WO 2014/036085 to this drawback is to apply filters that remove certain spatial cues from the emitted signal.

Another quite similar approach is published within the patent application WO 2014/107714, also referring to loudspeaker setups in which upward firing drivers are used for a height audio signal. Here, the above discussed drawback regarding the sufficient directionality for a broad frequency range may also be present.

In the patent applications U.S. Pat. No. 5,953,432 and U.S. Pat. No. 8,345,883 different approaches, being base on usage of beamforming, are revealed.

Some patent applications try to enhance the acoustic stage. For example, U.S. Pat. No. 2,179,840 shows loudspeakers playing back the content in three different frequency regions, wherein the loudspeakers are arranged such that they direct the sound towards the ceiling. From there, the reflected sound reaches the listener. According to this approach, this results in a better uniform distribution of the sound throughout the room.

The patent document U.S. Pat. No. 2,710,662 describes a sound diffusing projector for single channel or stereophonic sound reproduction. This projector generates virtual sources by using a loudspeaker slanted towards the side at the back of the device.

U.S. Pat. No. 2,831,060 shows methods of reproducing speech or music by means of loudspeakers radiating the sound to a listener partly directly and partly indirectly. U.S. Pat. No. 2,896,736 discloses a specific loudspeaker enclosure that enhances the reproduced sound field by using reflected sound. U.S. Pat. No. 3,241,631 describes a device that uses reflections from the wall in front of the listener instead of using side-wall reflections as the state of the art does. U.S. Pat. No. 3,582,553 describes a loudspeaker design that uses rearward-and-sideward oriented loudspeakers and second order reflections to reproduce stereophonic sound. U.S. Pat. No. 3,627,948 shows a loudspeaker design for stereophonic playback having forwardly and rearwardly as well as upward-slanted directed loudspeakers. U.S. Pat. No. 3,933,219 shows a loudspeaker design making use of using second order reflections from rear walls and 2nd side walls.

U.S. Pat. No. 4,112,256 discloses a loudspeaker design that emits different frequency ranges in different directions (upwards and towards the side) to achieve a considerably improved stereo reproduction. This has a liveliness and airiness to an extent which is missing with loudspeakers having their means facing straight forward.

U.S. Pat. No. 4,837,825 discloses an ambience recovery system that makes use of auxiliary loudspeakers positioned above a pair of conventional loudspeakers to physically separate the emitted additional sound by reflecting it off of sound-reflective surfaces.

To summarize, the advantages of the above discussed known technology is an enhancement in the spatial quality of the generated sound field, wherein the enhancement is based on the fact that reflected sound makes stereophonic reproduction better and more realistic. However, none of the above state of the art documents reveals an approach enabling to deliver immersive (i.e. 3D) sound reproduction in a home environment where placing loudspeakers around a listening space is not advantageous.

### SUMMARY

According to an embodiment a soundbar to be arranged within a room such that a vertical surface within the room is used for a vertical reflection and a horizontal surface of the room is used for a horizontal reflection may have: a housing: at least two transducers of a first group arranged at a front side of the housing and configured to emit sound in a first direction in accordance with at least two first audio signals including many channels so as to reproduce a two dimensional sound field; and at least one transducer of a second group arranged at a second side of the housing and configured to emit sound in a second direction in accordance with at least one second audio signal such that the sound emitted by the at least one transducer of the second group reaches a predefined listener position in a reflected manner to extend the two dimensional sound field in a height dimension; wherein a height audio signal of a 3D surround reproduction is reproduced using one or more transducers of the second group; wherein the sound emitted by the at least one transducer of the second group is reflected by the vertical surface first and by the horizontal surface second, wherein the reflection reflecting the sound emitted by the at least one transducer of the second group has an order of at least two.

According to another embodiment a system may have: an inventive soundbar; and a screen for reflecting the sound emitted by the at least one transducer of the second group or a vertical reflector for reflecting the sound emitted by the at least one transducer of the second group and/or a horizontal reflector for reflecting the sound emitted by the at least one transducer of the second group.

According to another embodiment a system may have: a soundbar and a screen, wherein the soundbar is to be arranged within a room such that a vertical surface within the room is used for a vertical reflection and a horizontal surface of the room is used for a horizontal reflection and wherein the soundbar includes: a housing: at least two transducers of a first group arranged at a front side of the housing and configured to emit sound in a first direction in accordance with at least two first audio signals including many channels so as to reproduce a two dimensional sound field; and at least one transducer of a second group arranged at a second side of the housing and configured to emit sound in a second direction in accordance with at least one second audio signal such that the sound emitted by the at least one transducer of the second group reaches a predefined listener position in a reflected manner to extend the two dimensional sound field in a height dimension; wherein a height audio signal of a 3D surround reproduction is reproduced using one or more transducers of the second group, wherein the sound emitted by the at least one transducer of the second group is reflected by the vertical surface first and by the horizontal surface second, wherein the reflection reflecting the sound emitted by the at least one transducer of the second group has an order of at least two, wherein the sound emitted by the at least one transducer of the second group is shielded by a back surface of the screen such that the screen forms a barrier shielding the sound that is erroneously emitted within the first direction.

According to another embodiment a system may have: a soundbar; and a screen for reflecting the sound emitted by the at least one transducer of the second group or a vertical reflector for reflecting the sound emitted by the at least one transducer of the second group and a horizontal reflector for reflecting the sound emitted by the at least one transducer of the second group; wherein the soundbar is to be arranged within a room such that a vertical surface within the room is used for a vertical reflection and a horizontal surface of the room is used for a horizontal reflection and wherein the soundbar includes: a housing: at least two transducers of a first group arranged at a front side of the housing and configured to emit sound in a first direction in accordance with at least two first audio signals including many channels so as to reproduce a two dimensional sound field; and at least one transducer of a second group arranged at a second side of the housing and configured to emit sound in a second direction in accordance with at least one second audio signal such that the sound emitted by the at least one transducer of the second group reaches a predefined listener position in a reflected manner to extend the two dimensional sound field in a height dimension; wherein a height audio signal of a 3D surround reproduction is reproduced using one or more transducers of the second group; wherein the sound emitted by the at least one transducer of the second group is reflected by the vertical surface first and by the horizontal surface second, wherein the reflection reflecting the sound emitted by the at least one transducer of the second group has an order of at least two.

According to another embodiment a soundbar arranged within a room such that a vertical surface within the room is used for a vertical reflection and a horizontal surface of the room is used for a horizontal reflection may have: a housing: at least two transducers of a first group arranged at a front side of the housing and configured to emit sound in a first direction in accordance with at least two first audio signals including many channels so as to reproduce a two dimensional sound field; and at least one transducer of a second group arranged at a second side of the housing and configured to emit sound in a second direction in accordance with at least one second audio signal such that the sound emitted by the at least one transducer of the second group reaches a predefined listener position in a reflected manner to extend the two dimensional sound field in a height dimension; wherein a height audio signal of a 3D surround reproduction is reproduced using one or more transducers of the second group; wherein the sound emitted by the at least one transducer of the second group is reflected by the vertical surface first and by the horizontal surface second, wherein the reflection reflecting the sound emitted by the at least one transducer of the second group has an order of at least two.

According to another embodiment a soundbar may have: a housing: at least two transducers of a first group arranged at a front side of the housing and configured to emit sound in a first direction in accordance with at least two first audio signals so as to reproduce a two dimensional sound field; and at least one transducer of a second group arranged at a second side of the housing and configured to emit sound in a second direction in accordance with at least one second audio signal such that the sound emitted by the at least one transducer of the second group reaches a predefined listener position in a reflected manner to extend the two dimensional sound field in a height dimension; wherein a height audio signal of a 3D surround reproduction is reproduced using at least one transducer of the second group; wherein the first and the second direction form an angle of more than 90°; or wherein the housing includes a recess within the second side and wherein the at least one transducer of the second group is arranged within the recess; and wherein the at least one transducer of the second group is arranged at one plane of the V-shaped recess which is turned away from the front side.

According to another embodiment a system may have: a soundbar and a screen, wherein the soundbar includes: a housing: at least two transducers of a first group arranged at a front side of the housing and configured to emit sound in a first direction in accordance with at least two first audio signals so as to reproduce a two dimensional sound field; and at least one transducer of a second group arranged at a second side of the housing and configured to emit sound in a second direction in accordance with at least one second audio signal such that the sound emitted by the at least one transducer of the second group reaches a predefined listener position in a reflected manner to extend the two dimensional sound field in a height dimension; wherein a height audio signal of a 3D surround reproduction is reproduced using at least one transducer of the second group, wherein the sound emitted by the at least one transducer of the second group is shielded by a back surface of the screen such that the screen forms a barrier shielding the sound that is erroneously emitted within the first direction.

According to another embodiment a system may have: a soundbar; and a screen for reflecting the sound emitted by the at least one transducer of the second group or a vertical reflector for reflecting the sound emitted by the at least one transducer of the second group and a horizontal reflector for reflecting the sound emitted by the at least one transducer of the second group; wherein the soundbar includes: a housing: at least two transducers of a first group arranged at a front side of the housing and configured to emit sound in a first direction in accordance with at least two first audio signals so as to reproduce a two dimensional sound field; and at least one transducer of a second group arranged at a second side of the housing and configured to emit sound in a second direction in accordance with at least one second audio signal such that the sound emitted by the at least one transducer of the second group reaches a predefined listener position in a reflected manner to extend the two dimensional sound field in a height dimension; wherein a height audio signal of a 3D surround reproduction is reproduced using at least one transducer of the second group; wherein the sound emitted by the at least one transducer of the second group is reflected by the screen or the vertical reflector first and by the horizontal reflector second, wherein the reflection reflecting the sound emitted by the at least one transducer of the second group has an order of at least two.

Another embodiment may have a use of a soundbar arranged within a room such that a vertical surface within the room is used for a vertical reflection and a horizontal surface of the room is used for a horizontal reflection, the soundbar including: a housing; at least two transducers of a first group arranged at a front side of the housing and configured to emit sound in a first direction in accordance with at least two first audio signals so as to reproduce a two dimensional sound field; and at least one transducer of a second group arranged at a second side of the housing and configured to emit sound in a second direction in accordance with at least one second audio signal such that the sound emitted by the at least one transducer of the second group reaches a predefined listener position in a reflected manner to extend the two dimensional sound field in a height dimension; wherein a height audio signal of a 3D surround reproduction is reproduced using at least one transducer of the second group; wherein the sound emitted by the at least one transducer of the second group is reflected by the vertical surface first and by the horizontal surface second, wherein the reflection reflecting the sound emitted by the at least one transducer of the second group has an order of at least two.

An embodiment of the invention provides a soundbar comprising a housing and at least two transducers of a first group and at least one transducer of a second group. The at least two transducers of a first group are arranged at a front side of the housing and configured to emit sound in a first direction in accordance with two first audio signals so as to reproduce a two dimensional sound field. The at least one transducer of a second group is arranged at the second side of the housing and configured to emit sound in a second direction in accordance with at least one second audio signal such that the sound emitted by the at least one transducer of the second group reaches a predefined listener's position in a reflected manner to extend the two-dimensional sound field in a height direction. The reflection utilized for the sound emitted by the at least one transducer of the second group has an order of at least two.

Teachings disclosed herein are based on the principle that a soundbar enabling the reproduction of virtual two dimensional surround sound may be enhanced with additional transducers for the height signal. The height signal is reproduced using one or more transducers of a second group which are arranged such that they emit sound in a different direction, e.g. towards the ceiling, or first to the back wall and after reflecting the signal at the back wall up to the ceiling such that the signal reflected by the ceiling impinges the listener at the listener's position. This manner of reflecting the signal, which may also be referred to as second order reflection, has benefits with regards to the directionality of the (height) sound signal. That is, that only one single enclosure containing a plurality of loudspeakers is used to enable three-dimensional spatial sound reproduction.

According to the embodiments, the soundbar is arranged within the room such that the back wall (i.e. the wall behind the soundbar as seen from the listener's direction) is used for the vertical reflection (first reflection) and the ceiling is used for the horizontal reflection (second reflection). According to further embodiments a screen, which may be arranged adjacent to the soundbar or at the soundbar, may be used for vertically reflecting the sound. According to a further option, the sound is emitted behind the screen such that the sound signal to be transmitted in a reflected manner is shielded by the screen, which forms a kind of a barrier. In order to arrange the screen in the correct position relatively to the soundbar, the soundbar may comprise means for mounting the screen.

Further embodiments refer to the arrangement of the at least one transducer of a second group relatively to the at least two transducers of the first group. Here, the at least one transducer of the second group has a tilt such that the second direction and the first direction form an angle of at least 90° or more. Therefore, the transducers of the two groups may also comprise an exterior angle β in between. Alternatively, the angle of the first and second direction may be formed using beamforming. According to further embodiments, the housing may have a recess, e.g. at the top side, wherein the at least one transducer of the second group is arranged within this recess. According to embodiments, the recess may have a V-shape such that the at least one transducer of the second group is arranged at a plane of the V-shaped recess which is turned away from the front side at which the transducers of the first group are arranged. Thus, the transducers of the first and second groups have an enclosed/interior angle α of less than 90°, e.g. 80°. Thus, it is ensured that the second direction directs to the back wall (if the first direction is directed in parallel to the floor of the room, which is the typical arrangement of a soundbar) so as to enable the second order reflections. Note that the recess may have a different shape (depending on its optimization for the used transducers) and could serve the purpose to enable wave-guiding (i.e. forming a waveguide).

According to further embodiments, the transducers of the first and the second group are of the same type, i.e. that transducers have the same frequency response. Due to this, the reproduction of dedicated channels over the entire relevant frequency range at distinct different positions is enabled.

A further embodiment provides a system comprising the above described soundbar and a screen for reflecting the sound emitted by the at least one transducer of the second group. Alternatively to the screen, the soundbar may have a vertical reflector, e.g. for the case a projector is used. Additionally, a horizontal reflector may be used, e.g. in case the ceiling is too high.

### BRIEF DESCRIPTION OF THE DRAWINGS

Embodiments of the present invention will be detailed subsequently referring to the appended drawings, in which:

FIG. 1a, 1b show a soundbar according to a basic embodiment;

FIGS. 2a, 2b show different perspectives of a soundbar according to an enhanced embodiment;

FIGS. 2c-2g show exemplary setups of the soundbar of FIGS. 2a, 2b;

FIGS. 3a, 3b show further embodiments of soundbars having a complex transducer arrangement;

FIGS. 4a, 4b show further embodiments of soundbars having an alternative transducer arrangement;

FIG. 5 shows a special setup with two soundbars;

FIGS. 6a, 6b show further embodiments of soundbars having a complex transducer arrangement together with their respective setup;

FIG. 7a shows a test setup of the upward oriented loudspeaker/soundbar according to an embodiment; and

FIG. 7b shows a diagram illustrating the results of the measurement using the test equipment of FIG. 7a.

### DETAILED DESCRIPTION OF THE INVENTION

Below, embodiments of the present invention will subsequently be discussed referring to the figures. Here, reference numerals are provided to objects having the same or similar function, so that the description thereof is mutually applicable and interchangeable.

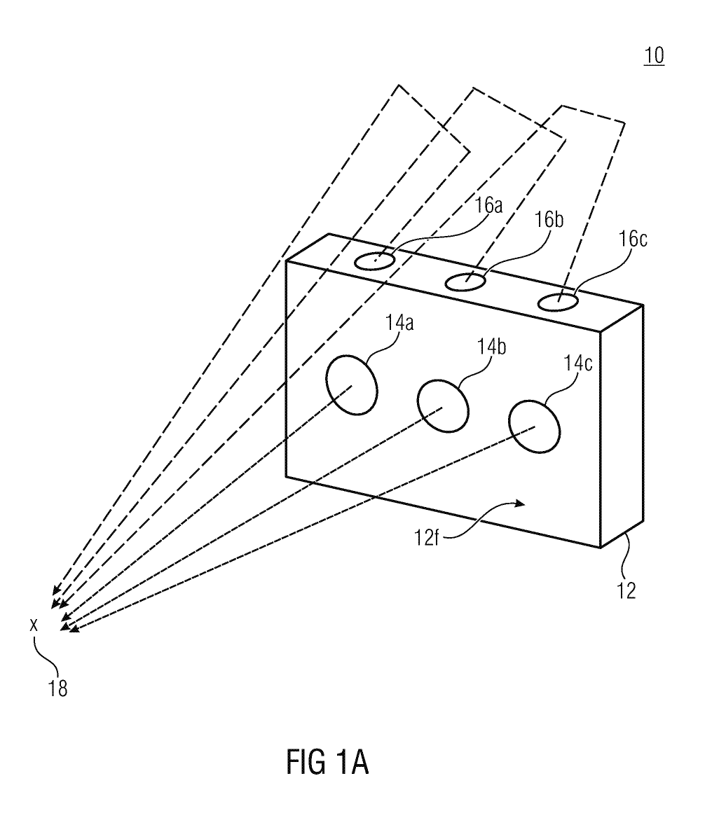

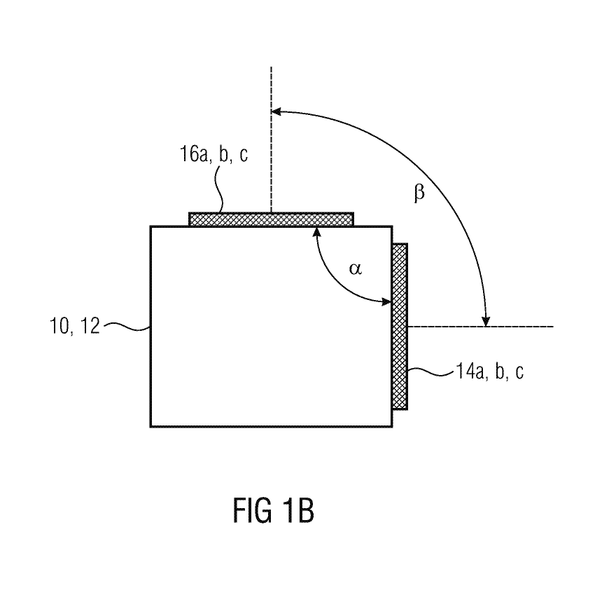

FIG. 1a shows a soundbar 10 comprising the housing 12 and at least two transducers of a first group 14a to 14c and at least one transducer of a second group 16a to 16c. As illustrated, the transducers 14a to 14c are arranged at a front side 12f of the housing 12, wherein the transducers 16a to 16c are arranged on another side, e.g. the top side of the housing 12.

From another point of view, that means that the transducers 14a to 14c as well as the transducers 16a to 16c form a tilt having an angle α of 90° or less, cf. FIG. 1b illustrating a side view of the soundbar 12. Due to the tilt the first direction into which the transducers 14a to 14c emit sound and the second direction into which the transducers 16a to 16c emit sound form an angle β in between which has 90° or more (cf. FIG. 1b). Note that the transducers 14a to 14c and 16a to 16c of the different groups are advantageously, but not necessarily, of the same type.

For example, the transducers 14a to 14c emit sound substantially in a direction in parallel to the floor, i.e. directly to the listener at listening position 18 so as to enable two-dimensional surround sound. It should be noted that the surround sound is based on the common principle of producing virtual surround sound using a soundbar. Virtual surround sound means that a single soundbar generates sound seeming to come from directions where no loudspeakers are posited. The sound emitted by the transducers 16a to 16c is radiated in a direction basically against the wall behind the soundbar 10, such that the sound is reflected at the vertical wall. The sound reflected at the wall travels now in the direction towards the ceiling, at which the sound is reflected again. The second direction is slanted such that the sound reaches the listener at the listening position 18 after being reflected twice. Due to the fact that the sound travels from the ceiling to the listener at the position 18, the radiated sound wave mainly reaches the listener from above. Therefore, it is possible to use these second order reflections for height reproduction. From another point of view that means that the two-dimensional sound reproduction provided by the transducers 14a to 14c is extended vertically to form a three-dimensional sound reproduction at the listener's position 18.

From the point of view describing the (electrical) audio signals for controlling of the soundbar 10 it should be noted that the transducers 14a and 14c are typically controlled using, for example, two different audio signals (in order to enable two dimensional sound reproduction), wherein the transducers 16a to 16c are typically controlled by another audio signal.

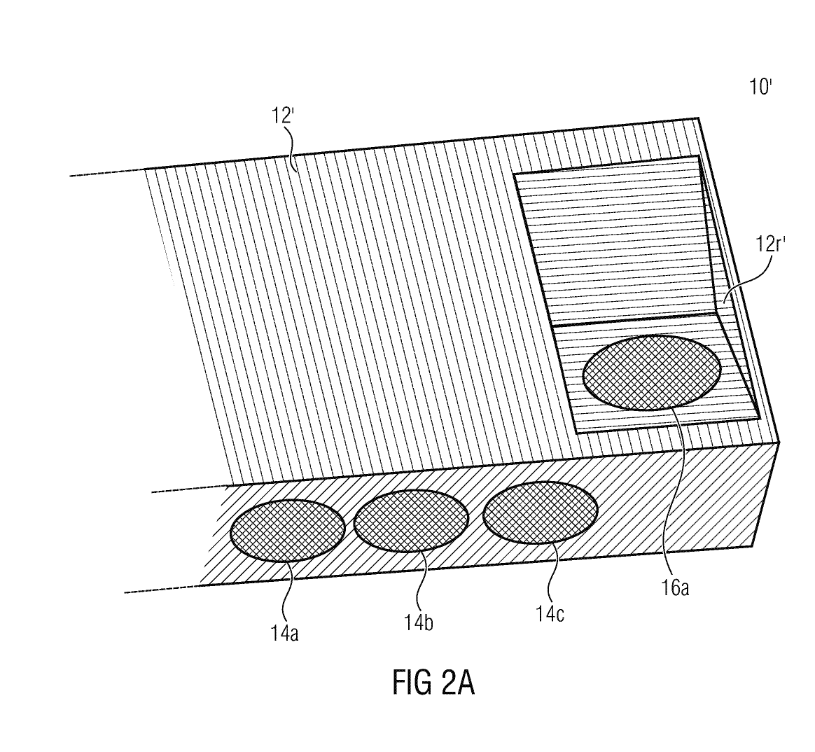

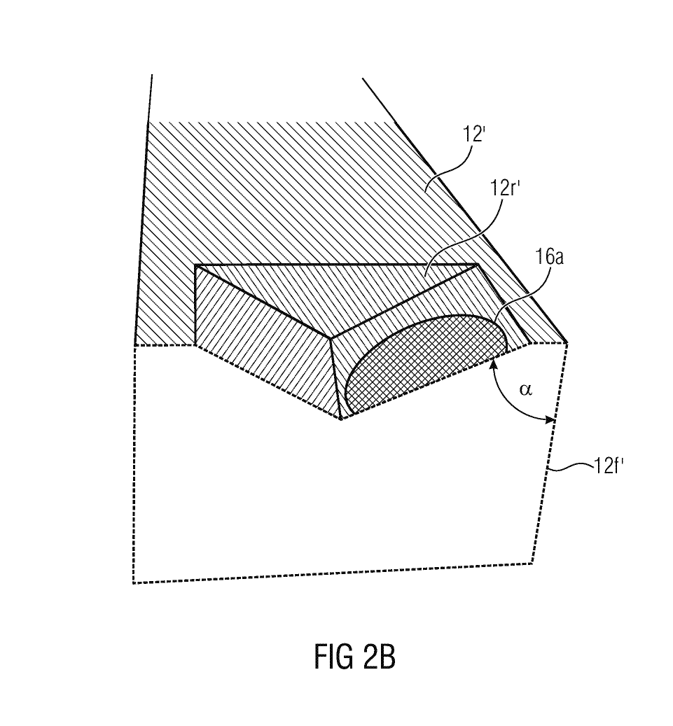

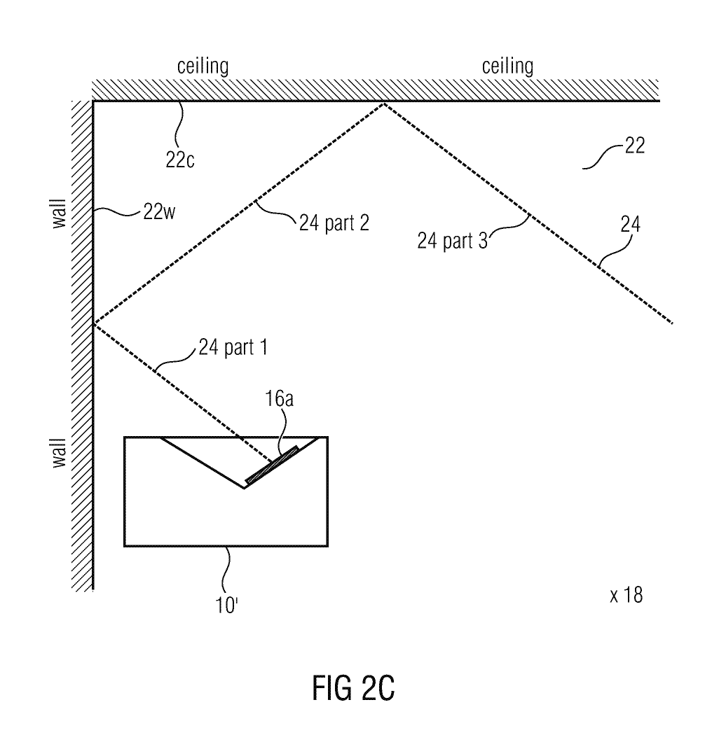

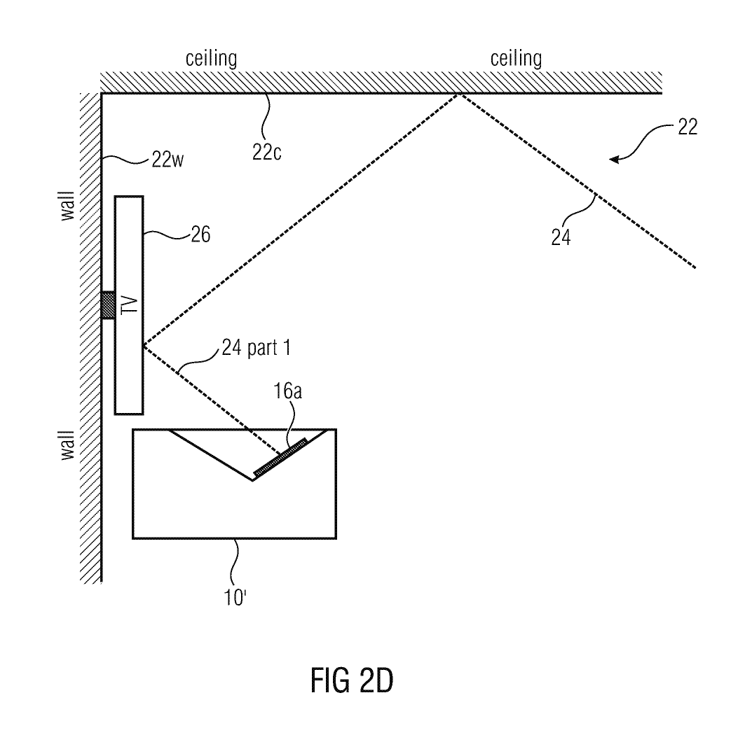

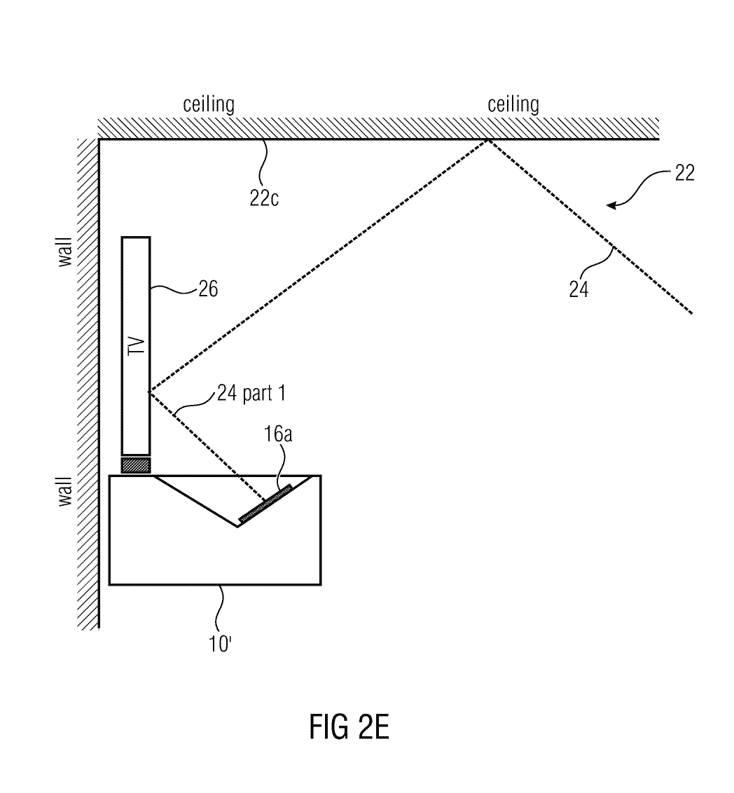

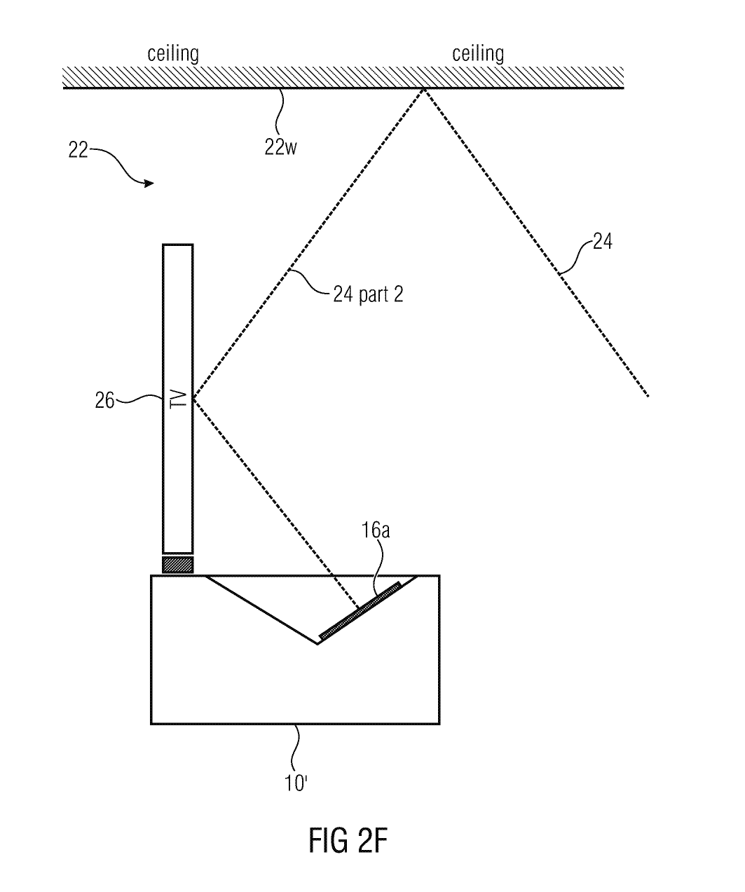

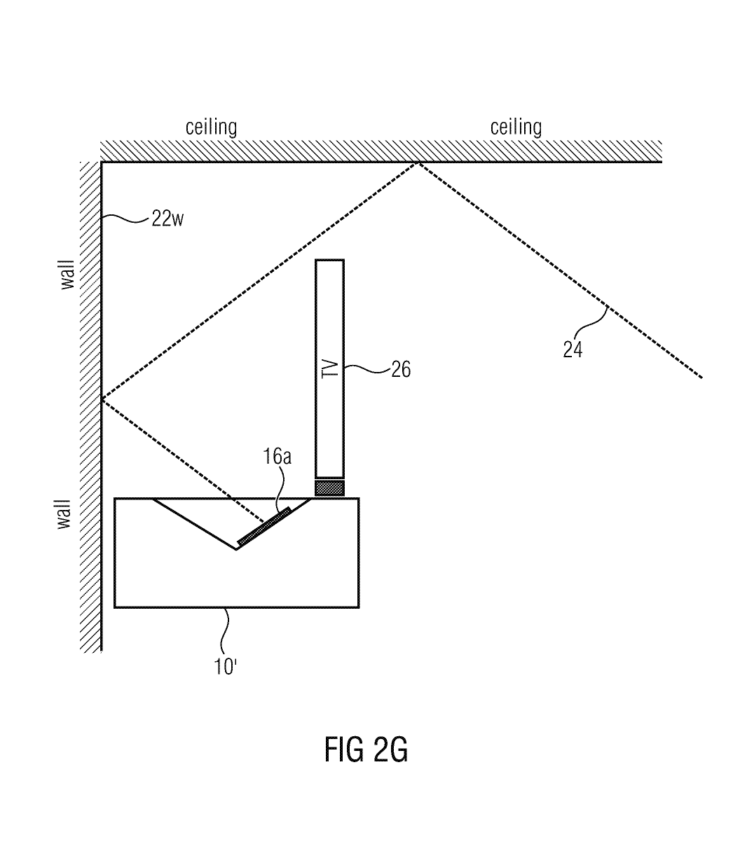

FIG. 2a shows a top view of a soundbar 10′ with three transducers 14a to 14c facing horizontally (e.g. towards the listening area) and one exemplary transducer 16a on the right side of the housing 12′, wherein the transducer 16a faces backward and upward back slanted away from the listening area. For this, the transducer 16a is arranged within a recess 12r′ of the housing 12′, wherein the recess 12r′ may have a V-shape. The transducer 16a is arranged at a plane of the recess 12r′ which forms together with the front 12f′ of the housing 12′ (onto which the transducers 14a to 14c are arranged) an acute angle α. This angle is illustrated by FIG. 2b.

Thus, the soundbar-like device 10′ can be defined as follows: a device 10′ that comprises at least three loudspeaker drivers 14a to 14c and 16a that are primarily excited in the same frequency range. This device 10′ is typically located near the bottom of a television screen, such that a dimension and width are comparable to those of a typical TV screen. A height is typically well below 30 cm, while a depth can vary such that it can, e.g. be conventionally placed in front of a TV screen or the TV screen can be based on the device itself. The loudspeaker drivers 14a to 14c and 16a may or may not share an enclosure 12′, but they will in any case be mechanically connected to each other such that their relative position to each other is fixed or can be fixed, i.e. that the housing does not necessarily form a volume for the transducers 14a to 14c and 16a. Although such device 10′ is typically used in conjunction with a TV screen, a standalone usage for music or radio reproduction is also possible.

In such a soundbar-like device 10′ at least one loudspeaker driver 16a is arranged or electrically steered such that it emits a sound wave that is consecutively reflected by a vertically oriented surface (like a wall) and then by a horizontally oriented surface before it impinges in the listening area (not shown). Using such a second order reflection is a crucial aspect of this invention. Arranging a loudspeaker basically means to tilt it accordingly, while an electrical steering can be facilitated using multiple drivers combined with array processing techniques.

Loudspeaker drivers 16a used for height reproduction will typically be mounted on top of the housing 12′ and principally emit the sound in an upward direction.

To achieve reflections on at least two surfaces, it is additionally beneficial to facilitate a primary radiation direction that is slightly pointing away from the intended listening position.

Due to this, the so-called precedence effect may be avoided. The precedence effect, which often influences the state of the art approaches, has the following background. Since neither tilting a conventional loudspeaker nor an electrical steering can achieve a perfect directional reproduction, the sound emission in the desired direction is accompanied by undesired sound emission. If such an undesired sound emission arrives earlier at the listener and with a certain sound pressure level, the reproduction signal will no longer be perceived as coming from above. Since the undesired sound emission is stronger in directions close to the desired direction, it is a clear advantage to aim at a primary radiation direction away from the listener. In contrast, the state-of-the-art proposes a radiation upwards but tilted towards the listener's position (cf. WO 2014/036085). This orientation is unavoidable when exploiting only first-order reflections. Due to the usage of second order reflections, the means for reducing the precedence effect, e.g. a filter for the high channels, are no longer needed.

Using second order reflections, the path from a loudspeaker driver to the listener is longer than for a first order reflection. The path (cf. reference numeral 24) is illustrated by FIG. 2c. FIG. 2c shows the soundbar 10′ arranged within a room 22 having the walls 22w and the ceiling 22c. The soundbar 10′ is arranged next to the wall 22w such that the signal output by the transducer 16a is directed against the wall 22w (cf. path 24, part 1). After being reflected, the path is between the wall 22w and ceiling 22c (cf. 24, part 2). Here, the signal is reflected such that it travels from the ceiling 22c to the listener at the listening position 18 (cf. 24, part 3).

The traveling path 24 from driver 16a to the listener position 18 is slightly longer than the traveling path of the first order reflection at the ceiling 22c causing only a small attenuation of the desired sound coming from above. But since tilting away the driver from the listener has an even stronger attenuation effect on the undesired direction, e.g. the first direction into which the transducers 14a to 14c of the first group emit the sound, this results in an overall improvement of the desired signal to inference signal ratio. Furthermore, the longer traveling path has the additional benefit of broadening the area which is covered by the sound reflected from the ceiling 22c. A directive reproduction with a given opening angle limits the effective listening area. Hence, a longer traveling distance to the emitted wave front will effectively increase the area where an optimum reproduction is achieved.

Seen from the listener's position 18, there are two essentially different options to place the driver 16a or the soundbar 10′. The driver 16a/soundbar 10′ can be placed in front of the TV screen 26 as illustrated by FIG. 2d or 2e. FIGS. 2d and 2e show the soundbar 10′ within the room 22, wherein the sound path 24 or especially part 1 of the sound path 24, i.e. 24, part 1, is emitted to the TV screen 26 which reflects the sound to the ceiling 22c. The difference between the embodiments 22d and 22e is that the screen 26 is mounted on the wall in case of the embodiment of 22d, wherein the television (screen) is positioned on the pedestal soundbar 10′ within the embodiment of 22e. From another point of view, that means that the soundbar 10′ may comprise means for mounting the screen 26. This has two advantages, namely that the soundbar 10′ and the television 26 may be arranged somewhere in the room 22 without the need of having the wall 22w behind the soundbar 10′.

This setup is illustrated by FIG. 2f showing soundbar 10′ in combination with the screen 26, wherein both are positioned in the middle of the room 22. As can be seen, the signal emitted by the transducer 16a reaches the ceiling 22w after being reflected by the screen 26 (cf. 24 part 2 of the path 24). Another advantage is that the vertical reflecting element, namely the television screen 26 is fixed and the position thereof is known. This makes the setup a variable solution for nearly each room.

Another option for placing the soundbar 10′ is to place same behind the screen 26, which results in different properties of the device. This embodiment is illustrated by FIG. 2g. FIG. 2g shows the soundbar 10′ arranged as discussed with respect to FIG. 2c (i.e. that the soundbar emits a sound signal traveling along the sound path 24 using the transducer 16a), wherein the television 26 is arranged at the front side of the soundbar 10′. The result of this arrangement is that the transducer 16a is arranged between the wall 22w and the screen 26. This has the effect that the sound emitted by the transducer 16a is shielded by the back side of the screen 26. Expressed in other words, that means that the driver 16a is located behind the TV screen 26. Thus, the vertically oriented reflecting surface will be the back wall 22w behind the TV screen 26. In that case, the TV screen 26 acts as an acoustic barrier to further reduce the undesired emission of the sound towards the listener without being reflected. This is considered to further improve the reproduction quality. Additionally, such an arrangement is desirable from an psychologic/esthetic point of view because the upwards pointing loudspeaker driver 16a′ is hidden from the listener's eyes and the front of the TV screen 26 can be arranged in line with the front of the device 10′.

Additionally, it should be noted that if the device is used without a TV screen 26, it should be positioned near the reflecting wall 22w. Although the acoustic barrier through the TV screen 26 is missing in that case, a height reproduction will still be possible. The performance will be comparable to the setup which uses the TV screen 26 as a reflector. Here, it should be noted that an alternative reflector may be provided. Thus, embodiments refer to a system comprising the soundbar, e.g. the soundbar 10 or 10′, and a vertically oriented reflector. In this case, or in most cases, the horizontally oriented reflecting object will be the listening room ceiling 22c. However, if the listening room is very high, there might be an additional reflector (not shown) suspended at an appropriate height.

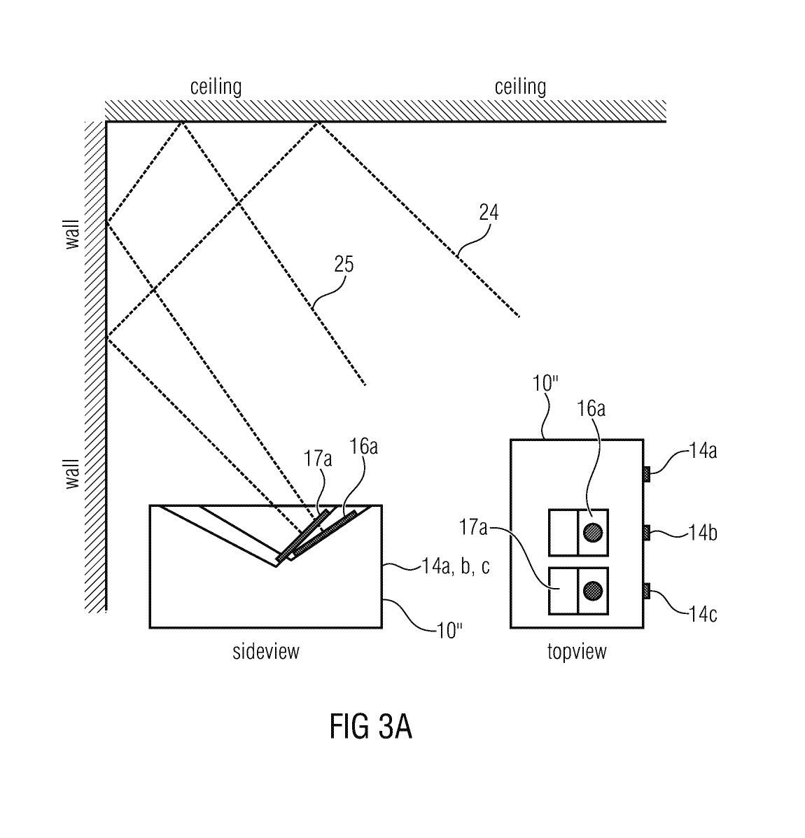

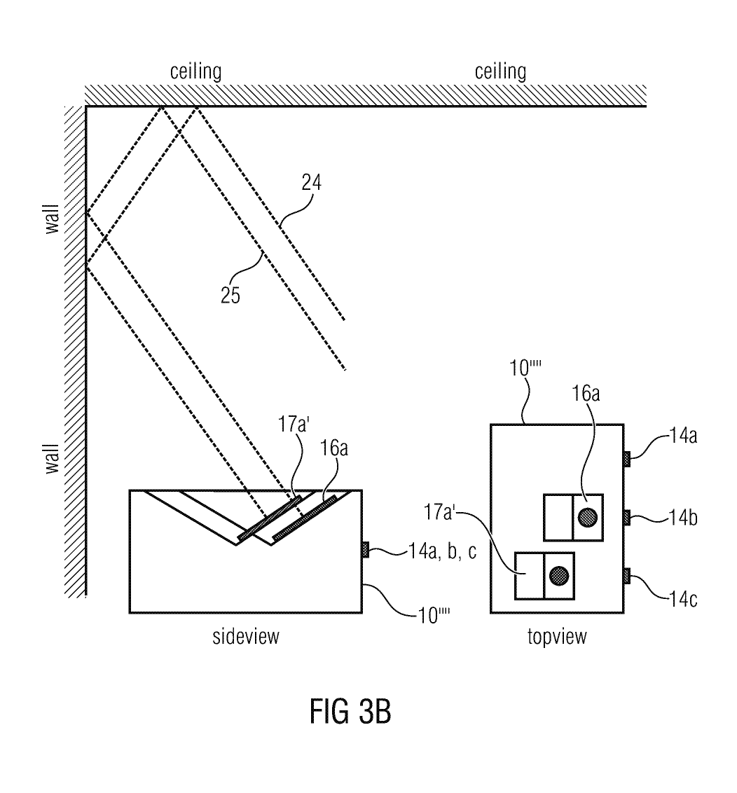

FIG. 3a shows an enhanced embodiment of the soundbar, namely the soundbar 10″. The soundbar 10″ comprises the transducers 14a to 14c at the front side and the at least one transducer of a second group 16a at the top side. Additionally, a further transducer 17a is arranged at the top side, wherein this further transducer 17a forms a different angle with respect to the transducers 14a to 14c. Consequently, the transducers 17a and 16a form an angle in between, as illustrated by the top view of the device 10″. The transducers 16a and 17a may be arranged adjacent to each other on the top side, or in more detail within a recess of the top side.

Due to the different tilts of the transducers 16a and 17a, the transducers emit sound signals traveling along the paths 24 and 25, wherein both paths are paths having reflections of a second order. Due to the two different paths 24 and 25, it is possible to transmit two (equal or different) height signals impinging the listener at the listener's position. As illustrated, the two different paths 24 and 25 impinge the listener's position such that one signal (cf. path 25) impinges at the front of the listener's position, wherein the second signal 24 impinges behind the listener at the listening position. Expressed in other words, this means that the two impinging sound signals 24 and 25 have different inclination angles in order to provide a wider listening area. Another use case for two or more drivers with different tilts are drivers which are used for the reproduction of different frequency ranges of the signal that is to be reproduced from above. And since different types of speakers, e.g. a broadband speaker and an additional tweeter, have different directivity characteristics, different tilt angles can be used to optimize the radiation pattern.

A similar effect may be achieved using the transducers 16a and 17a′ arranged at the top side of the soundbar 10′″ as illustrated by FIG. 3b. Here, the transducers 16a and 17a′ are arranged in parallel to each other (i.e. have the same angle between the respective transducers 17a′ and 16a and the transducers 14a to 14c, wherein the transducers 17a′ and 16a are arranged with different distances to the longitudinal side of the transducer 10″″ as illustrated by the top view of the transducer 10″″. Due to this, the sound signals 24 and 25 impinge at the listener's position such that a wider listening area is covered by their reflected sound 24 and 25.

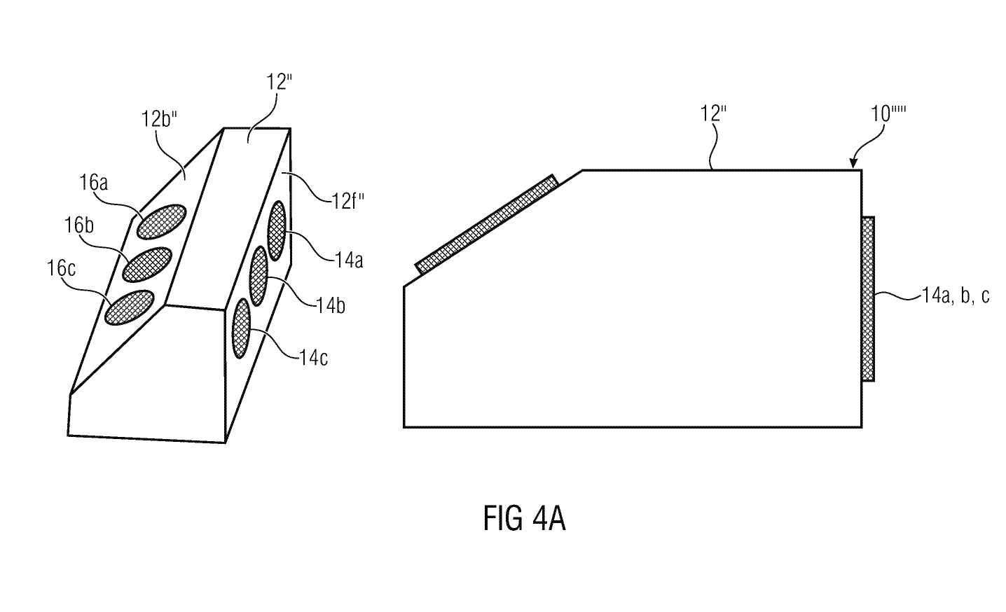

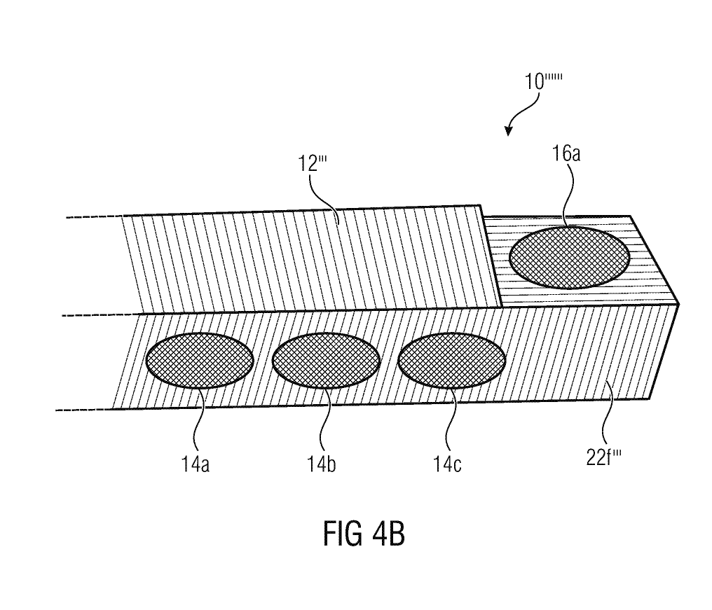

Although the above embodiments have been discussed in the context of a soundbar having a rectangular cross-section, it should be noted that the soundbar may also have a different shape, as illustrated by FIG. 4a.

FIG. 4a shows a soundbar 10′″″ having a pentagonal housing 12″, wherein the transducers 14a to 14c are arranged at the front side 12f″ and wherein a plurality of transducers of the second group 16a to 16c are arranged at a beveled plane 12b″ which is arranged opposite to the plane 12f″. As a consequence of this, the planes 12b″ and 12f″ and consequently, the directions into which the sound is emitted by the transducers 14a to 14c and 16a to 16c forms an angle β in between which has more than 90°, e.g. 100° or 110°.

FIG. 4b shows another embodiment of a housing of a soundbar 10″″″, wherein the housing 12′″ has a rectangular cross-section. Here, the transducers 14a to 14c are arranged at the front side 12f″, wherein the transducers 16a arranged at the top side of the housing 12′″ is arranged at a portion of the top side which is angled with respect to the entire top side, such that the angle portion of the top side forms an angle β with respect to the front side 12f″ being larger than 90°.

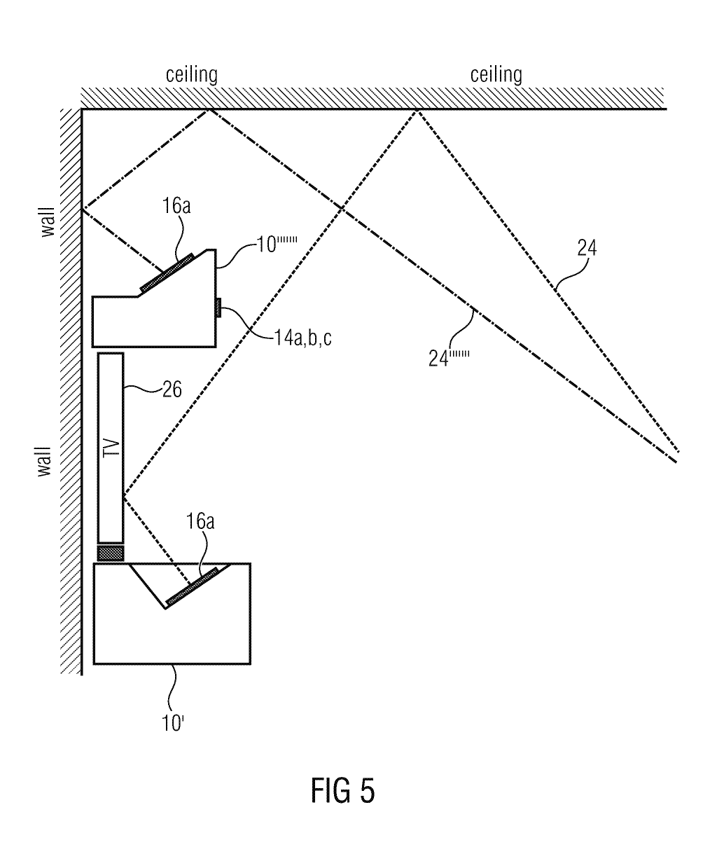

FIG. 5 shows an exemplary sketch of using more than one soundbar. Here, the soundbar 10′ is arranged below the TV screen 26, as explained with respect to the embodiment of FIG. 2e, wherein an additional soundbar 10′″″″ is arranged above the TV screen 26. Here, the soundbar 10′″″″ has an orthogonal shape, wherein the transducers 14a to 14c and 16a of the two different groups are arranged such that same form an angle α of 90° or less in between. In this example, the respective second emission direction of the transducer 16a of the two soundbars 10′ and 10′″″″ are selected such that both impinge at the listener's position, cf. part 24 and 24′″″″.

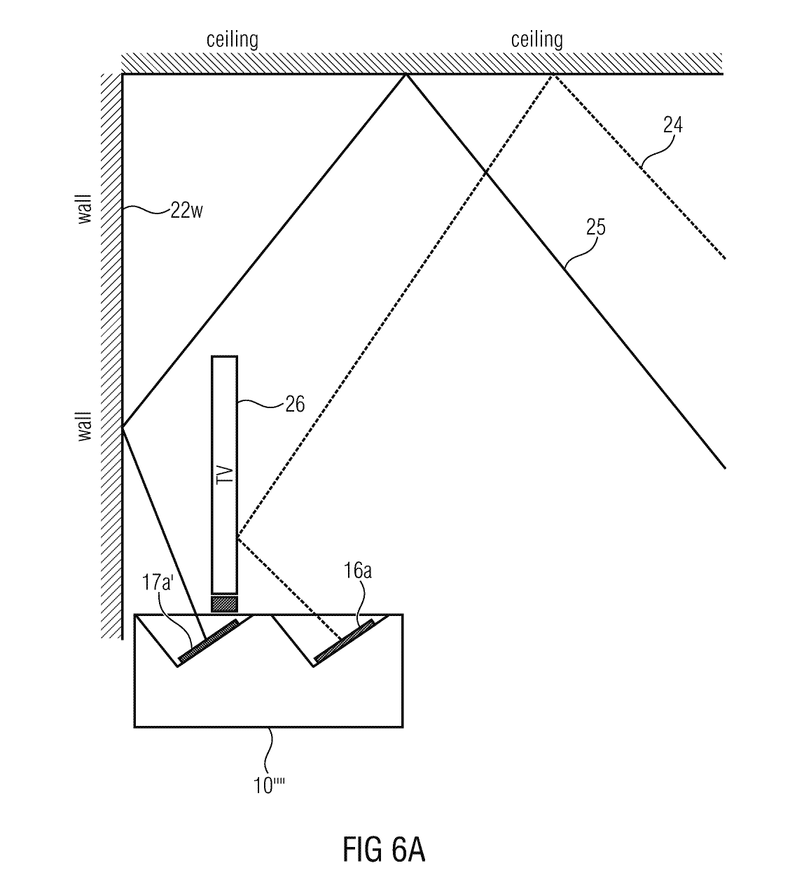

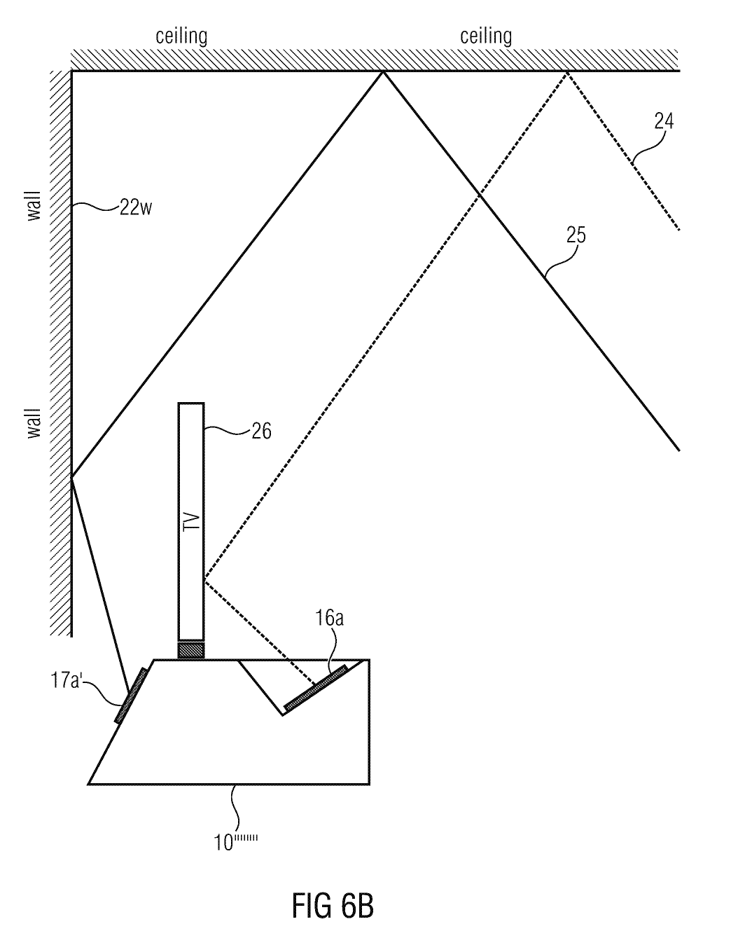

FIG. 6a shows a setup of the soundbar 10″″ which has the two transducers 16a and 17a′ being arranged with different distances to the longitudinal edge of the sample 10″″, wherein the screen 26 is arranged such that the signal of the transducer 16a is reflected by the screen 26 and such that the signal of the transducer 17a′ is emitted behind the screen 26 and reflected by the wall 22w and shielded by the screen 26. As illustrated by the two paths 24 and 25, the height audio signal impinges at the listener's position in a manner having a wider listening area.

A substantially similar situation is illustrated by FIG. 6b, wherein the soundbar 10″″″″ has the transducer 16a arranged at a recess in the top side and a transducer 17a′ arranged at a back side of the housing, wherein the back side and the front side have a tilt α of less than 90°. Consequently, the signal of the transducer 16a is reflected by the screen 26, wherein the signal of the transducer 17a′ is reflected by the wall 22w. As a consequence, the two audio signals 24 and 25 impinge at the listener's position in a manner forming a wider listening area.

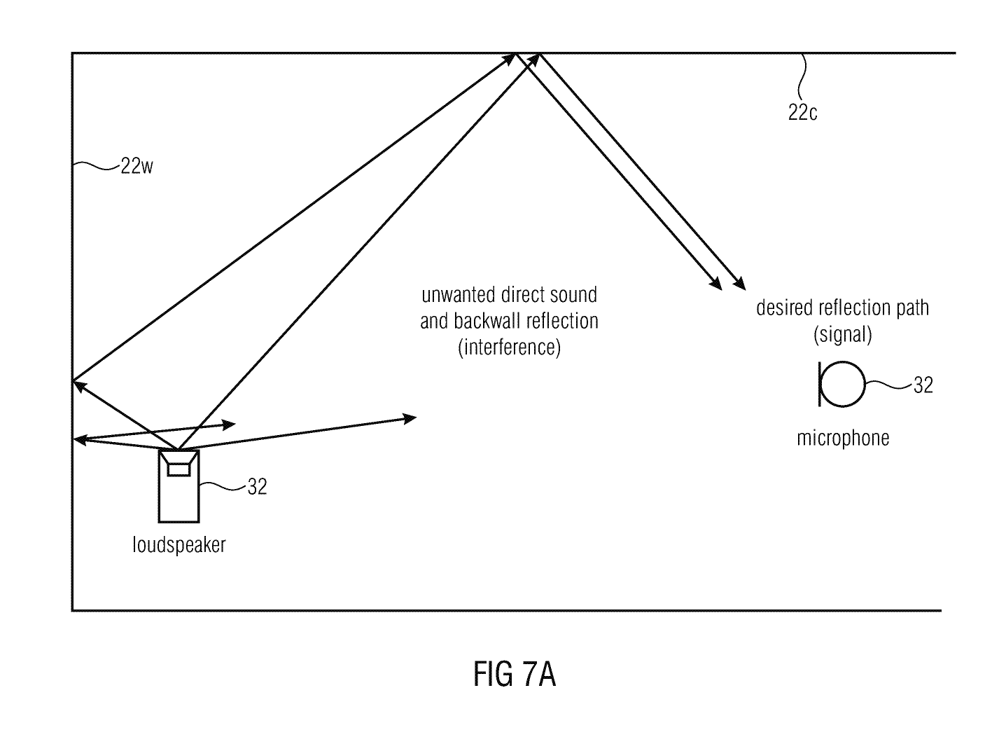

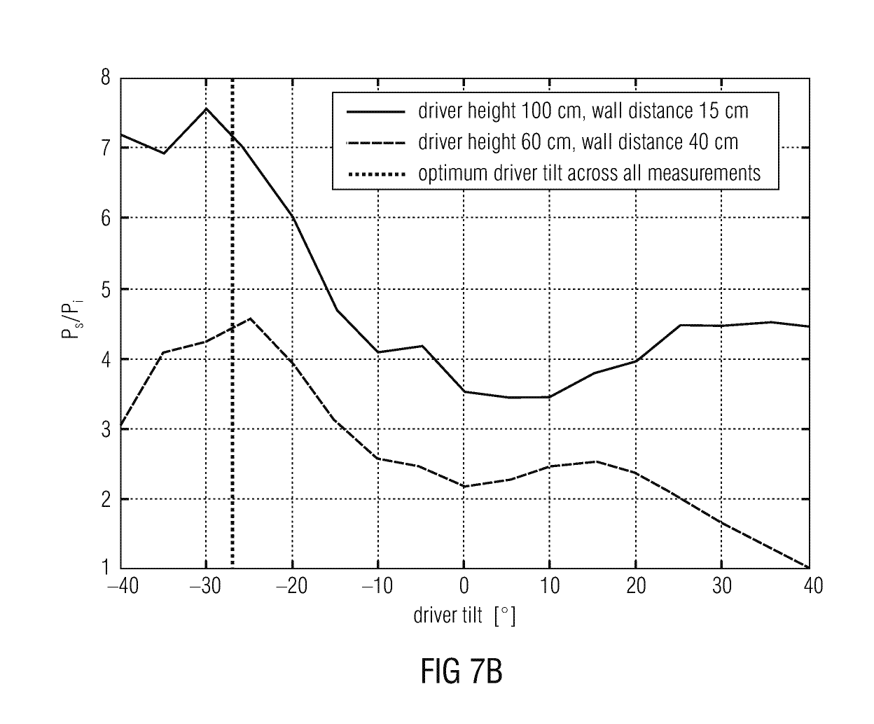

Wth respect to FIGS. 7a and 7b the benefits of tilting upward-oriented loudspeakers 16a towards the back wall 22w instead of directly towards the ceiling 22c will be discussed. Here, FIG. 7a shows the test setup in which the test loudspeaker 30 is arranged next to the back wall 22w and the microphone 32 at the listener's position. The test loudspeaker 30 is generally oriented upwards, wherein the tilt is varied during the measurement.

The results for two different vertical positions of the test speaker 30 of the measurement is illustrated by FIG. 7b. FIG. 7b shows a diagram of the desired reflection path signal (p_{signal}) and the unwanted interference signal (p_{interference}) plotted over the driver tilt.

In the test setup of FIG. 7 the upward oriented loudspeaker 30, is placed closely to the wall 22w at different heights and wall distances, and the microphone 32 is at 2.5 meter from the wall. The transfer function between the loudspeaker 30 and the microphone 32 is measured for variety of driver tilt angle ranging from −45° to +45°, wherein negative angles describe an orientation towards the back wall 22w. Sound reaching the listener from the front, either directly or via a first order reflection, are considered unwanted and their respective energy is accumulated into the total interference power (p_{interference}). All sound reaching the listener via reflections from the top, i.e. from the ceiling 22c, e.g. via first order or second order reflections (i.e. “ceiling to listener”, or “back wall to ceiling to listener”), are considered desired signal p_{signal}. Thus, the optimum loudspeaker tilt angle is indicated by a maximum of the energetic ratio between the signal and interference, pₛ to pᵢ. An advantage of the backward-oriented loudspeaker is that less energy propagates on the direct unwanted path to the listener as compared to the case when the loudspeaker is oriented directly towards the ceiling (cf. FIG. 7b). This effect is even emphasized towards higher frequencies, as the loudspeaker starts to focus.

Although some of the above embodiments have been discussed in the way that just one transducer of the second group (cf. reference numeral 16a) is arranged at the top side or back side or the recess of the soundbar, it should be noted that a plurality of transducers of the second group may be arranged at the top side.

In some embodiments, the side at which the transducers of the second group are arranged has been discussed so to form an angle α being smaller than 90° to enable angle of larger than 90° between the first and second emission direction, it should be noted that the angle β may also be 90° or more (cf. FIG. 1b). However the interior angle α may also be equal or larger than the 90° when beamforming is used to direct the second direction so that the angle β between the first and the second direction amounts to at least 90° or to more than 90°.

Referring to the above discussed one or more audio signals used for controlling the traducers of the first and second group, it should be noted that each audio signal (first/second audio signal) may comprise many channels, the first/second audio signal may comprise many channels.

Additionally it should be noted that the first and second audio signals differ from each other with respect to their content (e.g. they are provided by different discrete audio channels), or the difference may consist of (but is not limited to) gain modification, decorrelation and/or filtering, e.g. high-pass filtering, which are ideally time varying and/or frequency dependent.

Referring to the height information of the second audio signal it should be noted that the height information may be carried by a separated channel or generated by an upmixing.

Here, it should be noted that the above embodiments are just illustrative, wherein the scope of protection is limited by the following claims.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A soundbar to be arranged within a room such that a vertical surface within the room is used for a vertical reflection and a horizontal surface of the room is used for a horizontal reflection, the soundbar comprising:
a housing:
at least two transducers of a first group arranged at a front side of the housing and configured to emit sound in a first direction in accordance with at least two first audio signals comprising many channels so as to reproduce a two dimensional sound field; and
at least one transducer of a second group arranged at a second side of the housing and configured to emit sound in a second direction in accordance with at least one second audio signal such that the sound emitted by the at least one transducer of the second group reaches a predefined listener position in a reflected manner to extend the two dimensional sound field in a height dimension;
wherein a height audio signal of a 3D surround reproduction is reproduced using one or more transducers of the second group;
wherein the sound emitted by the at least one transducer of the second group is reflected by the vertical surface first and by the horizontal surface second, wherein the reflection reflecting the sound emitted by the at least one transducer of the second group comprises an order of at least two.

2. The soundbar according to claim 1, wherein the horizontal reflection is performed using a ceiling of the room in which the soundbar is arranged.

3. The soundbar according to claim 1, wherein the sound emitted by the at least one transducer of the second group is reflected in a vertical manner by a wall of the room, the wall being behind the soundbar; or
wherein the sound emitted by the at least one transducer of the second group is reflected in a vertical manner by a screen which is vertically arranged adjacent to the soundbar.

4. The soundbar according to claim 3, wherein the soundbar comprises a unit for mounting the screen.

5. The soundbar according to claim 1, wherein the at least one transducer of the second group comprises a tilt such that the second direction and the first direction form an angle comprising 90° or more; and/or
wherein the second group comprises at least two transducers and wherein the sound of the at least two transducers of the second group is emitted using beam forming such that the second direction and the first direction form an angle comprising 90° or more.

6. The soundbar according to claim 1, wherein the first and the second direction form an angle of more than 90°.

7. The soundbar according to claim 1, wherein the second group comprises two subgroups, each subgroup comprising at least one transducer, wherein the transducers of the two subgroups differ from each other with regard to an enclosed angle and/or with regard to a distance to a longitudinal edge of the housing.

8. The soundbar according to claim 1, wherein the at least two transducers of the first group and the at least one transducer of the second group are of the same type; and/or
wherein the at least two transducers of the first group and the at least one transducer of the second group exhibit the same frequency response.

9. The soundbar according to claim 1, wherein the second group comprises at least two transducers.

10. The soundbar according to claim 1, wherein the at least two transducers of the first group and/or the at least one transducer of the second group are configured to emit sound such that sound is horizontally directed away from the predefined listener position.

11. The soundbar according to claim 1, wherein the housing comprises a recess within the second side; and
wherein the at least one transducer of the second group is arranged within the recess.

12. The soundbar according to claim 11, wherein the recess comprises a V-shape; and
wherein the at least one transducer of the second group is arranged at one plane of the V-shaped recess which is turned away from the front side.

13. The soundbar according to claim 1, wherein the first audio signals differ from the second audio signals.

14. A system comprising:
a soundbar according to claim 1; and
a screen for reflecting the sound emitted by the at least one transducer of the second group or a vertical reflector for reflecting the sound emitted by the at least one transducer of the second group and/or a horizontal reflector for reflecting the sound emitted by the at least one transducer of the second group.

15. A system comprising:
a soundbar and a screen,
wherein the soundbar is to be arranged within a room such that a vertical surface within the room is used for a vertical reflection and a horizontal surface of the room is used for a horizontal reflection and wherein the soundbar comprises:
a housing:
at least two transducers of a first group arranged at a front side of the housing and configured to emit sound in a first direction in accordance with at least two first audio signals comprising many channels so as to reproduce a two dimensional sound field; and
at least one transducer of a second group arranged at a second side of the housing and configured to emit sound in a second direction in accordance with at least one second audio signal such that the sound emitted by the at least one transducer of the second group reaches a predefined listener position in a reflected manner to extend the two dimensional sound field in a height dimension;
wherein a height audio signal of a 3D surround reproduction is reproduced using one or more transducers of the second group,
wherein the sound emitted by the at least one transducer of the second group is reflected by the vertical surface first and by the horizontal surface second, wherein the reflection reflecting the sound emitted by the at least one transducer of the second group comprises an order of at least two,
wherein the sound emitted by the at least one transducer of the second group is shielded by a back surface of the screen such that the screen forms a barrier shielding the sound that is erroneously emitted within the first direction.

16. The system according to claim 15, wherein the soundbar comprises a unit for mounting the screen.

17. A system comprising:
a soundbar; and a screen for reflecting the sound emitted by the at least one transducer of the second group or a vertical reflector for reflecting the sound emitted by the at least one transducer of the second group and a horizontal reflector for reflecting the sound emitted by the at least one transducer of the second group;
wherein the soundbar is to be arranged within a room such that a vertical surface within the room is used for a vertical reflection and a horizontal surface of the room is used for a horizontal reflection and wherein the soundbar comprises:
a housing:
at least two transducers of a first group arranged at a front side of the housing and configured to emit sound in a first direction in accordance with at least two first audio signals comprising many channels so as to reproduce a two dimensional sound field; and
at least one transducer of a second group arranged at a second side of the housing and configured to emit sound in a second direction in accordance with at least one second audio signal such that the sound emitted by the at least one transducer of the second group reaches a predefined listener position in a reflected manner to extend the two dimensional sound field in a height dimension;
wherein a height audio signal of a 3D surround reproduction is reproduced using one or more transducers of the second group;
wherein the sound emitted by the at least one transducer of the second group is reflected by the vertical surface first and by the horizontal surface second, wherein the reflection reflecting the sound emitted by the at least one transducer of the second group comprises an order of at least two.

18. A soundbar arranged within a room such that a vertical surface within the room is used for a vertical reflection and a horizontal surface of the room is used for a horizontal reflection, the soundbar comprising:
a housing:
at least two transducers of a first group arranged at a front side of the housing and configured to emit sound in a first direction in accordance with at least two first audio signals comprising many channels so as to reproduce a two dimensional sound field; and
at least one transducer of a second group arranged at a second side of the housing and configured to emit sound in a second direction in accordance with at least one second audio signal such that the sound emitted by the at least one transducer of the second group reaches a predefined listener position in a reflected manner to extend the two dimensional sound field in a height dimension;
wherein a height audio signal of a 3D surround reproduction is reproduced using one or more transducers of the second group;
wherein the sound emitted by the at least one transducer of the second group is reflected by the vertical surface first and by the horizontal surface second, wherein the reflection reflecting the sound emitted by the at least one transducer of the second group comprises an order of at least two.

19. The soundbar according to claim 18, wherein the horizontal reflection is performed using a ceiling of the room in which the soundbar is arranged; and
wherein the sound emitted by the at least one transducer of the second group is reflected in a vertical manner by a wall of the room, the wall being behind the soundbar; or wherein the sound emitted by the at least one transducer of the second group is reflected in a vertical manner by a screen which is vertically arranged adjacent to the soundbar.

20. A soundbar comprising:
a housing:
at least two transducers of a first group arranged at a front side of the housing and configured to emit sound in a first direction in accordance with at least two first audio signals so as to reproduce a two dimensional sound field; and
at least one transducer of a second group arranged at a second side of the housing and configured to emit sound in a second direction in accordance with at least one second audio signal such that the sound emitted by the at least one transducer of the second group reaches a predefined listener position in a reflected manner to extend the two dimensional sound field in a height dimension;
wherein a height audio signal of a 3D surround reproduction is reproduced using at least one transducer of the second group; wherein the first and the second direction form an angle of more than 90°; or wherein the housing comprises a recess within the second side and wherein the at least one transducer of the second group is arranged within the recess; and wherein the at least one transducer of the second group is arranged at one plane of the V-shaped recess which is turned away from the front side.

21. A system comprising:
a soundbar and a screen,
wherein the soundbar comprises:
a housing:
at least two transducers of a first group arranged at a front side of the housing and configured to emit sound in a first direction in accordance with at least two first audio signals so as to reproduce a two dimensional sound field; and
at least one transducer of a second group arranged at a second side of the housing and configured to emit sound in a second direction in accordance with at least one second audio signal such that the sound emitted by the at least one transducer of the second group reaches a predefined listener position in a reflected manner to extend the two dimensional sound field in a height dimension;
wherein a height audio signal of a 3D surround reproduction is reproduced using at least one transducer of the second group,
wherein the sound emitted by the at least one transducer of the second group is shielded by a back surface of the screen such that the screen forms a barrier shielding the sound that is erroneously emitted within the first direction.

22. A system comprising:
a soundbar; and a screen for reflecting the sound emitted by the at least one transducer of the second group or a vertical reflector for reflecting the sound emitted by the at least one transducer of the second group and a horizontal reflector for reflecting the sound emitted by the at least one transducer of the second group;
wherein the soundbar comprises:
a housing:
at least two transducers of a first group arranged at a front side of the housing and configured to emit sound in a first direction in accordance with at least two first audio signals so as to reproduce a two dimensional sound field; and
at least one transducer of a second group arranged at a second side of the housing and configured to emit sound in a second direction in accordance with at least one second audio signal such that the sound emitted by the at least one transducer of the second group reaches a predefined listener position in a reflected manner to extend the two dimensional sound field in a height dimension;
wherein a height audio signal of a 3D surround reproduction is reproduced using at least one transducer of the second group;
wherein the sound emitted by the at least one transducer of the second group is reflected by the screen or the vertical reflector first and by the horizontal reflector second, wherein the reflection reflecting the sound emitted by the at least one transducer of the second group has an order of at least two.

23. Use of a soundbar arranged within a room such that a vertical surface within the room is used for a vertical reflection and a horizontal surface of the room is used for a horizontal reflection, the soundbar comprising:
a housing:
at least two transducers of a first group arranged at a front side of the housing and configured to emit sound in a first direction in accordance with at least two first audio signals so as to reproduce a two dimensional sound field; and
at least one transducer of a second group arranged at a second side of the housing and configured to emit sound in a second direction in accordance with at least one second audio signal such that the sound emitted by the at least one transducer of the second group reaches a predefined listener position in a reflected manner to extend the two dimensional sound field in a height dimension;
wherein a height audio signal of a 3D surround reproduction is reproduced using at least one transducer of the second group;
wherein the sound emitted by the at least one transducer of the second group is reflected by the vertical surface first and by the horizontal surface second, wherein the reflection reflecting the sound emitted by the at least one transducer of the second group has an order of at least two.
